(19) United States
(12) Patent Application Publication
(10) Pub. No.: US 2012/0224313 A1
(43) Pub. Date: Sep. 6, 2012

(54) CABINET SERVER SYSTEM

(76) Inventors: Hangkong HU, Shenzhen (CN); Zhan Wu, Shenzhen (CN); Zhenyu Zhuang, Shenzhen (CN); Wenfei Tang, Shenzhen (CN)

(21) Appl. No.: 13/470,748

(22) Filed: May 14, 2012

Related U.S. Application Data
(63) Continuation of application No. PCT/CN2011/075050, filed on May 31, 2011.

(30) Foreign Application Priority Data
Jul. 9, 2010 (CN) 201010224840.8

(51) Int. Cl. G06F 1/20; G06F 1/16

(52) U.S. Cl. 361/679.4

(57) ABSTRACT

A cabinet server system includes a cabinet and a subrack located in the cabinet; the subrack includes a backplane; the subrack is capable of housing a removable middle baffle plate; and the subrack is configured to insert a server device of a first width when no middle baffle plate is inserted, and insert a server device of a second width when a middle baffle plate is inserted, where the server device of the first width and the server device of the second width are inserted into the backplane of the subrack, and are connected to other devices through the backplane.

### CROSS-REFERENCE TO RELATED APPLICATIONS

This application is a continuation of International Application No. PCT/CN2011/075050, filed on May 31, 2011, which claims priority to Chinese Patent Application No. 201010224840.8, filed on Jul. 9, 2010, both of which are hereby incorporated by reference in their entireties.

### FIELD OF THE APPLICATION

The present invention relates to a server, and in particular, to a cabinet server system.

### BACKGROUND OF THE APPLICATION

Because of fast development of the Internet and cloud computation, more requirements are imposed on servers that are the main implementations of the Internet and cloud computation. Cabinet servers, as a major form of network servers, have many advantages in comparison with rack servers, tower servers, and blade servers.

A cabinet for a cabinet server is typically 1200 mm wide. The cabinet includes two server device areas and the width of each server device is fixed. The front panels of all server devices provide cable interfaces for connecting to switches through cables and data is switched between the server devices and external network devices.

The width of each server device is the same and not compatible enough because each server device is connected to a switch through a cable and the cables need to be connected or disconnected during the installation or maintenance of the server devices and the maintenance is inconvenient.

### SUMMARY OF THE APPLICATION

Embodiments of the present invention provide a cabinet server system to solve the problems of the prior art such as poor compatibility and inconvenient maintenance.

An embodiment of the present invention provides a cabinet server system, including:

a cabinet and a subrack located in the cabinet;

where, the subrack includes a backplane;

the subrack is capable of housing a removable middle baffle plate;

the subrack is configured to receive a server device of a first width when no middle baffle plate is inserted; and receive a server device of a second width when a middle baffle plate is inserted;

where, the server device of the first width and the server device of the second width are inserted into the backplane of the subrack, and are connected to another device through the backplane.

As can be known from the above technical solution, in the cabinet server system provided in the embodiments of the present invention, a subrack capable of housing a removable middle baffle plate is arranged and server devices of different widths may be inserted into the subrack to achieve good compatibility; each server device is inserted into the backplane of the subrack and no cable needs to be connected to the server devices, so that the maintainability is improved.

### BRIEF DESCRIPTION OF THE DRAWINGS

To make the technical solution in the embodiments of the present invention clearer, the accompanying drawings used in the description of the embodiments are briefly described hereunder. Evidently, the accompanying drawings illustrate some exemplary embodiments of the present invention and persons of ordinary skill in the art can derive other drawings based on these drawings without creative efforts.

FIG. 1 is a schematic three-dimensional view of a system according to a first embodiment of the present invention;

FIG. 2 is a schematic view of a subrack according to the first embodiment of the present invention;

FIG. 3 is a schematic front view of a system according to a second embodiment of the present invention;

FIG. 4 is a schematic rear view of the system according to the second embodiment of the present invention;

FIG. 5 is a schematic view of the system where a power supply unit is connected to a backplane according to the second embodiment of the present invention;

FIG. 6 is a schematic view where a switch is directly connected to a backplane according to a third embodiment of the present invention;

FIG. 7 is a schematic view where a switch is connected to a backplane through a cable and a cable outlet according to a fourth embodiment of the present invention; and

FIG. 8 is a schematic view where a switch is connected to a backplane through a cable and a cable routing according to a fifth embodiment of the present invention.

### DETAILED DESCRIPTION OF THE EMBODIMENTS

To make the objective, technical solution, and advantages of the embodiments of the present invention clearer, the technical solution provided in the embodiments of the present invention is hereinafter described clearly and completely with reference to the accompanying drawings. Evidently, the described embodiments are only some exemplary embodiments of the present invention, rather than all embodiments of the present invention. Persons of ordinary skill in the art can derive other embodiments from the embodiments provided herein without making any creative effort and all such embodiments are covered in the protection scope of the present invention.

### Embodiment 1

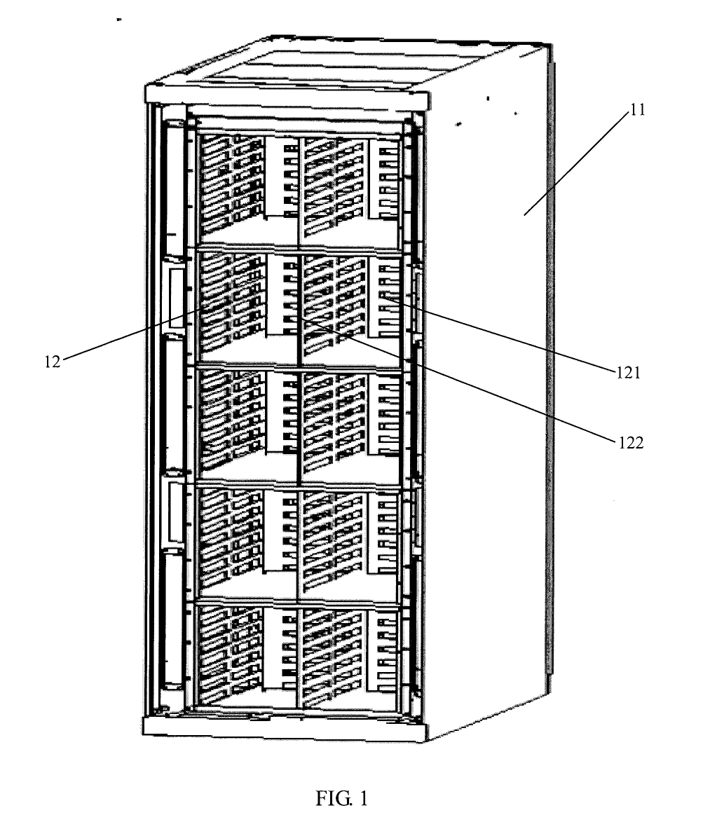

FIG. 1 is a schematic three-dimensional view of a system according to a first embodiment of the present invention. The system includes a cabinet 11 and a subrack 12. The subrack 12 is located in the cabinet 11. The subrack 12 includes a backplane 121 and is capable of housing a middle baffle plate 122, where the middle baffle plate 122 is removable, that is, the middle baffle plate 122 may or may not be inserted into the subrack 12. In the embodiment shown in FIG. 1, the middle baffle plate 122 is inserted into the subrack 12. By inserting or not inserting the middle baffle plate 122 into the subrack 12, the system may support server devices of different widths, therefore getting compatible with server devices of different widths. The subrack 12 is configured to receive a server device of a first width when no middle baffle plate is inserted; and receive a server device of a second width when a middle baffle plate is inserted (that is, server devices of the second width are separated by the middle baffle plate and therefore, they may be inserted on the left side and right side of the middle baffle plate in the subrack), where a server device is inserted into the backplane 121 of the subrack and is connected to another device (such as a switch) through the backplane. The server device is inserted into the backplane and is connected to another device through the backplane. Therefore, no cable is arranged on the server device and maintenance is easier.

In addition, the cabinet width in the embodiment may be a standard width, 600 mm, so that the granularity in deployment is reduced (that is, the size of the smallest unit is reduced) and therefore the flexibility is improved.

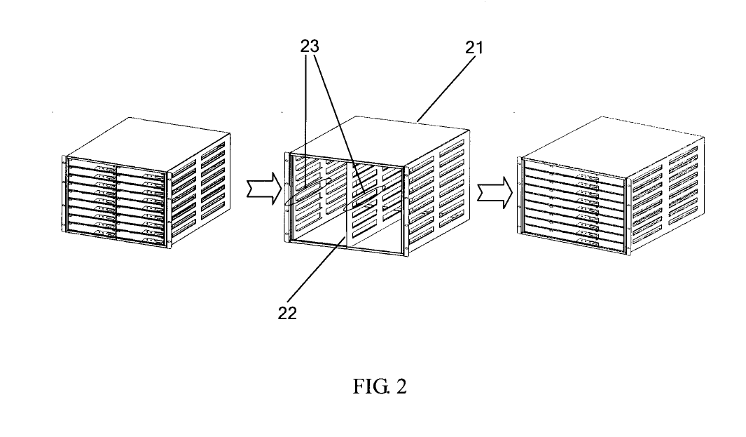

Specifically, FIG. 2 is a schematic view of a subrack according to the first embodiment of the present invention. The back end of each subrack is a backplane 21 configured to connect server devices. One or more slots 23 may be arranged in the subrack and server devices are placed in the subrack by using these slots. A middle baffle plate 22 may be arranged in the subrack. The middle baffle plate 22 is removable. When the middle baffle plate 22 is arranged in the subrack, a half-width server may be placed in the subrack (refer to the left side in FIG. 2). After the middle baffle plate 22 is removed, a full-width server may be placed in the subrack (refer to the right side in FIG. 2). By arranging or not arranging a middle baffle plate, the subrack may support servers of different widths, therefore getting compatible with servers of different widths. Specifically, the width of a full-width server may be less than 440 mm. In addition, a cable routing may be arranged on left and right sides of the subrack, so that cables can pass through.

Furthermore, due to the restrictions of the manufacturing material, cost, or process, the subrack should not be too high (if the subrack is too high, the strength is reduced, and the size of a corresponding backplane is increased, and therefore the implementation is more complex). The number of subracks arranged in each cabinet should be at least greater than two. If there is no restriction of the manufacturing material, cost, or process, it is also possible to arrange only one subrack and manufacture the corresponding backplane, which is not limited by the embodiment of the present invention.

In the embodiment, a subrack capable of housing a removable middle baffle plate is arranged and therefore server devices of different widths may be inserted into the subrack to achieve good compatibility; each server device is inserted into the backplane of the subrack and no cable needs to be connected to the server devices, so that the maintainability is improved.

### Embodiment 2

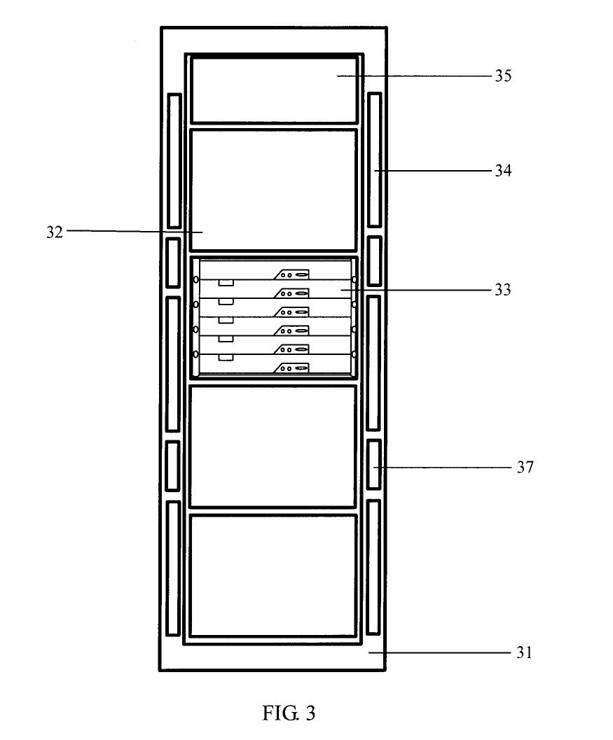

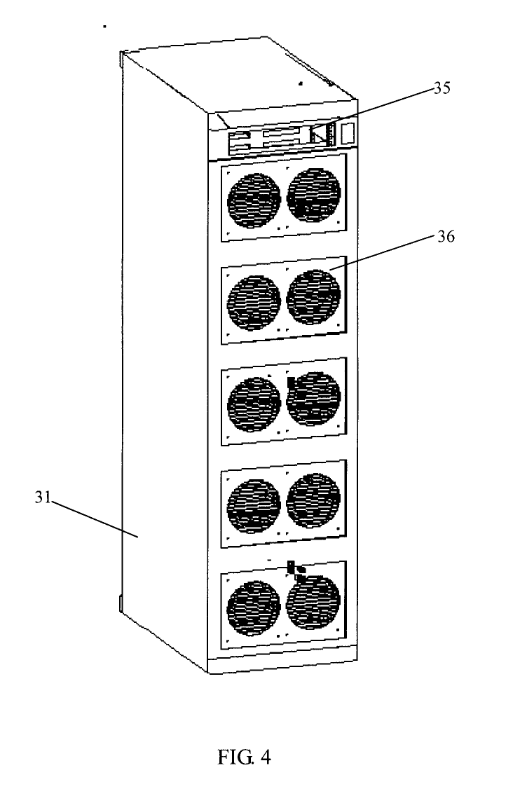

FIG. 3 and FIG. 4 are schematic front and rear views of a system according to a second embodiment of the present invention, respectively. The system in the embodiment includes a cabinet 31, a subrack 32, a server device 33, a switch device 34, a power supply unit 35, a fan module 36, and a backplane (the backplane is not shown herein due to restrictions of angles; for the backplane, refer to the schematic views in FIG. 1 and FIG. 2). The backplane is configured to connect to various devices and such connections may include electrical signal connections or may be only physical connections. For example, the backplane may connect to the server device, switch device, power supply unit, and fan module. Specifically, a connector of a device that needs to be connected to the backplane is connected to a connector of the backplane (the two connectors are a male connector and a female connector). The specific types of connector are not limited herein. Those skilled in the art may select appropriate connectors according to actual application conditions. When the server device is connected to the backplane, no additional cable is required. Therefore, the complexity of cabling is reduced and the maintenance is more convenient (the server system may be connected or disconnected as a whole and there is no need to connect or disconnect cables one by one).

The fan module 36 is configured to implement centralized heat dissipation for the devices in the cabinet 31. There may be one or more fan modules. To increase the system reliability, multiple fan modules 36 may be used. Referring to FIG. 4, the multiple fan modules 36 are located on the back side in the cabinet 31 so that centralized management and heat dissipation are implemented. In addition, these fan modules are independent of each other, that is, the damage of one fan module does not affect other fan modules. The type and number of fans are not limited herein. Selection may be made according to actual conditions. In the embodiment of the present invention, with the centralized management and heat dissipation of fans, fans do not need to be configured for each server device additionally and therefore the cost of each server device is reduced. In addition, the fans can be managed more conveniently. If one fan module is faulty, its heat dissipation function may be provided by other fan modules for the server device. In this process, there is no need to handle the server device and therefore services are not interrupted. The faulty fan may be maintained or replaced during later maintenance. The replacement process relates to only the faulty fan and does not affect the normal working of other fans. If centralized heat dissipation is not adopted and each server device is separately equipped with a fan module, when the fan of a server device is faulty, the server must be taken out for maintenance, which causes a server interruption.

The power supply unit 35 is connected to the backplane of the subrack 32 and configured to convert an input alternating current (AC) into a direct current (DC) and then supply power for all the server devices 33. Therefore, no additional AC/DC converter needs to be arranged in each server device and the design cost and design complexity of each server device are reduced. The power supply unit 35 may be located on the upper side in the cabinet 31 to implement centralized power supply. The power supply unit 35 may be located in other places and the specific location is not limited herein.

The server device 33 is inserted into the backplane of the subrack 32. The subrack 32 may be placed at the middle of the front part in the cabinet 31. The switch device 34 may be vertically placed on at least one of the two sides in the cabinet 31 to effectively utilize the remaining space of the cabinet, increase the device density, and facilitate cabling. In the embodiment, to maximally utilize the remaining space of the cabinet, a switch device 34 is placed on two sides in the cabinet.

A supporting rail may be arranged in the cabinet. The subrack 32, switch device 34, power supply unit 35, and fan module 36 are placed on the supporting rail, so that all these devices are placed in the cabinet 31.

The switch device 34 may be inserted into the backplane or connected to the backplane through a cable. When a cable connection is required, a cable outlet may be arranged on the cabinet and/or a cable routing may be arranged in the subrack.

Taking the cable outlet arranged on the cabinet as an example, FIG. 3 is a schematic front view of the system according to the second embodiment of the present invention. Referring to FIG. 3 and according to the above deployment, we can see from the front that: a power supply unit 35 is placed on the upper side of the cabinet 31; a subrack 32 is placed on the front side of the cabinet 31 and located in the middle area of the cabinet 31; a switch device 34 is placed on at least one of the left side and the right side in the cabinet 31 (in FIG. 3, it is assumed that a switch device is placed on the left side and the right side of the cabinet); in addition, a cable outlet 37 is arranged on the left side and the right side of the cabinet. For brevity, FIG. 3 does not illustrate the server device. It is understandable that the server device is located in the subrack and inserted into the backplane of the subrack.

FIG. 4 is a schematic rear view of the system according to the second embodiment of the present invention. Referring to FIG. 4, a fan module 36 may be arranged on the back side of a cabinet 31. There may be one or more fan modules 36. In FIG. 4, multiple fan modules 36 are illustrated and the multiple fan modules 36 form a fan wall. In addition, a power supply unit 35 is placed on the upper side of the cabinet 31. The power supply unit 35 may be seen from the back.

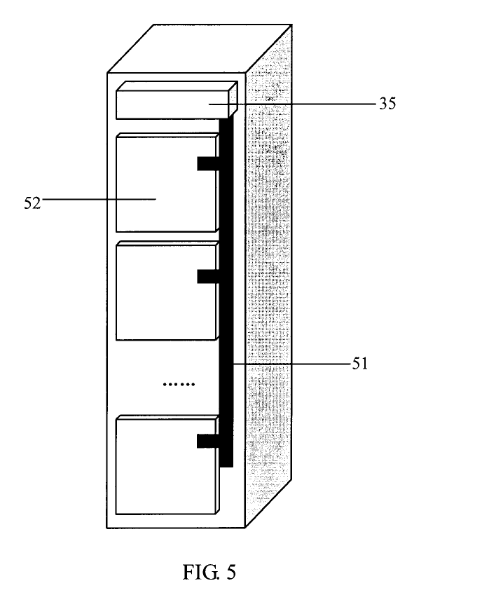

FIG. 5 is a schematic view of the system where the power supply unit is connected to the backplane according to the second embodiment of the present invention. Referring to FIG. 5, a power supply unit 35 may be connected to a backplane 52 of the subrack through a copper busbar 51 to supply a direct current for each server device; if there are multiple subracks (corresponding to multiple backplanes), the power supply unit 35 is connected to multiple backplanes.

In the embodiment, the power supply unit and fan module are uniformly arranged in the cabinet, instead of being arranged inside each server. Therefore, centralized power supply and heat dissipation may be implemented, the efficiency of power supply and heat dissipation is improved, the number of fans and power supply units is reduced, the hardware cost is reduced, and the system reliability is increased. With the subrack arranged in the cabinet, each server device is inserted into the backplane of the subrack and the switch device is also connected to the backplane. Therefore, the server device is connected to the switch device through the subrack and no cable needs to be connected to the server device, so that the maintainability is improved. In addition, when a cable outlet and a cable routing are arranged, communication may be implemented between the switch device and the server device in multiple ways, front cabling and back cabling are supported, and better compatibility is achieved. Furthermore, by placing a middle baffle plate, the subrack may support a full-width device and a half-width device and accommodate more different types of devices. Moreover, a standard width is adopted, the occupied width of the cabinet is decreased, and the granularity in cabinet deployment is reduced, which can achieve good compatibility with the deployment environment of an equipment room and improve flexibility.

In the embodiment of the present invention, to implement communication between the server device and the switch device, the switch device may be inserted into the backplane, and the switch device is connected to the backplane by a cable passing through a cable outlet, or the switch device is connected to the backplane by a cable passing through a cable routing arranged in the subrack. Details are provided in the following embodiments.

### Embodiment 3

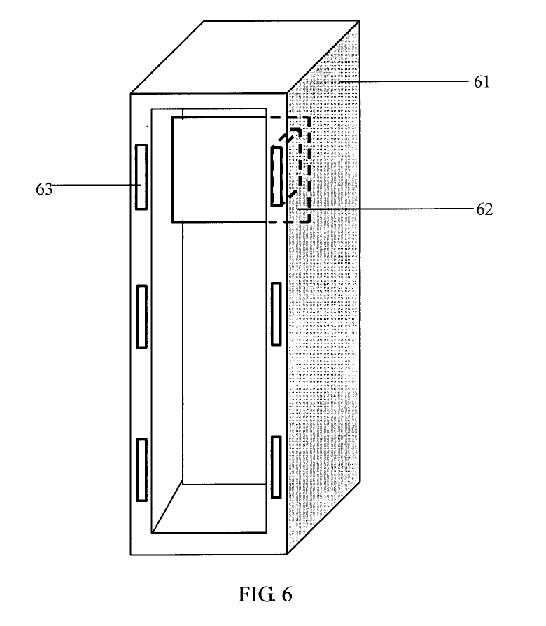

FIG. 6 is a schematic view where a switch is directly connected to a backplane according to a third embodiment of the present invention. Based on the first and second embodiments, this embodiment assumes that the switch is inserted into the backplane. Referring to FIG. 6, the system of this embodiment includes a cabinet 61, a backplane 62, and a switch device 63, where, the switch device 63 is inserted into the backplane 62.

It is understandable that the function, composition, and location relationship of other devices in the cabinet server system may refer to FIG. 1 to FIG. 5.

Because the server device is inserted into the backplane, when the switch device is also inserted into the backplane, communication may be implemented between the server device and the switch device through the backplane, cabling is simplified, and the maintenance difficulty and cost are reduced.

### Embodiment 4

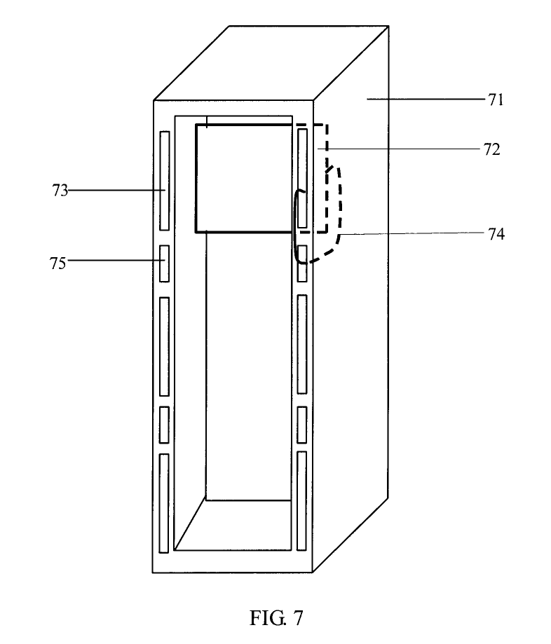

FIG. 7 is a schematic view where a switch is connected to a backplane through a cable and a cable outlet according to a fourth embodiment of the present invention. Based on the first and second embodiments, this embodiment assumes that the cable passes through the cable outlet on the cabinet. Referring to FIG. 7, the embodiment includes a cabinet 71, a backplane 72, and a switch device 73, and further includes a cable 74 and a cable outlet 75, where the cable 74 is connected to the backplane 72 and the cable 74 passes through the cable outlet 75 to connect to the front panel of the switch device 73.

It is understandable that the function, composition, and location relationship of other devices in the cabinet server system may refer to FIG. 1 to FIG. 5.

Some switches may not support direct connections to the backplane. In this case, according to the embodiment of the present invention, a cable outlet may be arranged and a cable is used to connect the switch to the backplane to increase applicability.

### Embodiment 5

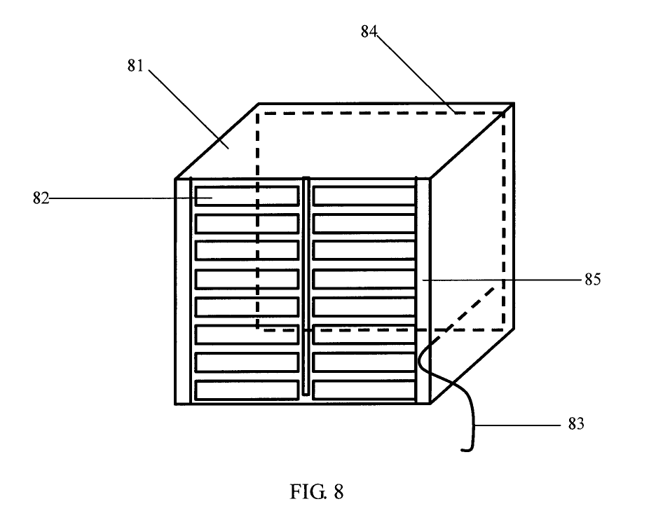

FIG. 8 is a schematic view where a switch is connected to a backplane through a cable and a cable routing according to a fifth embodiment of the present invention. Based on the first and second embodiments, this embodiment assumes that the cable passes through the cable routing in the subrack. Referring to FIG. 8, the embodiment includes a subrack 81, a server device 82, and a cable 83, where, the subrack includes a backplane 84 and a cable routing 85, the server device 82 is inserted into the backplane 84, one end of the cable is connected to the backplane, and the other end of the cable passes through the cable routing 85 in the subrack to connect to the front panel of the switch device.

It is understandable that the function, composition, and location relationship of other devices in the cabinet server system may refer to FIG. 1 to FIG. 5.

By arranging a cable routing in the subrack, the embodiment of the present invention facilitates cable maintenance as compared with the solution of the fourth embodiment. For example, when a faulty cable needs to be replaced, the solution of the fourth embodiment may require the movement of the entire cabinet and the maintenance staff needs to find a proper location for the replacement. Because the cabinet is large and heavy, it is inconvenient to move the cabinet. In the embodiment of the present invention, it is only necessary to pull out the subrack to replace the cable without moving the large and heavy cabinet. Therefore, the maintenance is more convenient.

Persons of ordinary skill in the art may understand that all or part of the steps in the method according to the embodiments can be implemented by hardware under the instruction of a program. The program may be stored in a computer readable storage medium and when the program runs, the steps in the method according to the embodiments are executed. The storage medium is any medium that can store program codes, such as a ROM, a RAM, a magnetic disk, or CD-ROM.

Finally, it should be noted that the embodiments of the present invention are intended for describing the technical solution of the present invention rather than limiting the technical solution of the present invention. Although the present invention is described in detail with reference to the foregoing embodiments, persons of ordinary skill in the art should understand that they can still make modifications to the technical solution described in the foregoing embodiments or make substitutions to some technical features thereof, without departing from the spirit and scope of the technical solution of the embodiments of the present invention.

What is claimed is:

1. A cabinet server system, comprising:
a cabinet and a subrack located in the cabinet;
wherein:
the subrack comprises a backplane;
the subrack is capable of housing a removable middle baffle plate;
the subrack is configured to receive a server device of a first width when no middle baffle plate is inserted; and receive a server device of a second width when a middle baffle plate is inserted;
wherein, the server device of the first width and the server device of the second width are inserted into the backplane of the subrack, and are connected to another device through the backplane.

2. The system according to claim 1, further comprising:
switch devices, vertically placed on at least one of the left side and the right side in the cabinet in sequence.

3. The system according to claim 2, wherein the backplane is further configured to:
receive the switch device so that the switch device is connected to the server devices through the backplane.

4. The system according to claim 2, wherein a cable outlet is arranged on the cabinet, and the system further comprises a cable connected to the backplane and configured to connect to the switch device through the cable outlet.

5. The system according to claim 2, wherein a cable routing is arranged in the subrack, and the system further comprises a cable connected to the backplane and configured to connect to the switch device through the cable routing.

6. The system according to claim 1, further comprising:
one or more independent fan modules, located on a back side in the cabinet, and configured to implement centralized heat dissipation for devices in the cabinet.

7. The system according to claim 1, wherein the cabinet server system includes multiple subracks vertically arranged in the middle of a front part in the cabinet.

8. The system according to claim 1, further comprising:
a power supply unit, located in the cabinet, connected to the backplane of the subrack, and configured to convert an alternating current into a direct current and supply power for all server devices.

9. The system according to claim 8, wherein the power supply unit is arranged on an upper side of the cabinet and is connected to the backplane of the subrack through a copper busbar.

10. The system according to claim 1, wherein the width of the cabinet is 600 mm.
